(19) United States
(12) Patent Application Publication
(10) Pub. No.: US 2014/0325278 A1
(43) Pub. Date: Oct. 30, 2014

(54) METHOD AND SYSTEM FOR INTERACTIVE AND AUTOMATED TESTING BETWEEN DEPLOYED AND TEST ENVIRONMENTS

(71) Applicant: VERIZON PATENT AND LICENSING INC., Basking Ridge, NJ (US)

(72) Inventor: Hassan M. OMAR, MT Vernon, NY (US)

(73) Assignee: Verizon Patent and Licensing Inc., Basking Ridge, NJ (US)

(21) Appl. No.: 13/870,705

(22) Filed: Apr. 25, 2013

(51) Int. Cl. G06F 11/263

(52) U.S. Cl. CPC G06F 11/263
USPC 714/33

(57) ABSTRACT

An approach for interactive automated testing and deployment/field troubleshooting includes extracting one or more field parameters associated with a deployed network resource management environment; determining and/or updating one or more test parameters associated with a test network resource management environment based on the one or more field parameters; inputting the determined and/or updated test parameters within the test network resource management environment to evaluate the one or more test parameters; and modifying a configuration of at least one of the deployed network resource management environment and the test network resource management environment based on the one or more evaluated test parameters.

### BACKGROUND INFORMATION

A typical communication session may include multiple traffic components such as voice, video and data. Each one of these components requires network resources, such as bandwidth, to ensure timely and accurate delivery of information. To allocate resources within the network, an application typically generates an allocation request directed towards a network resources management system (NRMS). The NRMS applies a set of policy based rules to verify if a resource allocation request can be accepted and notifies the requesting application accordingly. An example of a NRMS is a policy and charging rules function (PCRF) system to manage resources in long-term evolution LTE environments.

The NRMS's function is critical to the operational, functional and performance related aspects of a provider's network, with a direct impact on the quality of experience observed by the customer. Accordingly, accurate and reliable lab testing is needed to verify functional and performance aspects of the NRMS. Considering the complexity associated with the NRMS, and the number of elements that such a system needs to interact with, it is very likely that the appropriate values of some of the parameters needed for testing may not be known in advance before deployment in the field. Further, some of these parameters may change after deployment as a result of dynamic events, such as supporting a larger number of subscribers and the introduction of new services and elements. Another complexity associated with the operation of an NRMS is the ability to identify the exact cause of unexpected behavior, considering the amount of interactions between and dependency on the multiple systems involved.

Based on the foregoing, there is a need for an approach to support interactive and optimized testing for NRMSs.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a network resources management system (NRMS) environment, according to one embodiment;

FIG. 2 is a diagram of a system capable of interactive automated testing and deployment/field troubleshooting, according to one embodiment;

FIG. 3 is a diagram of an interactive testing and operation support (ITOS) platform capable of initiating and performing interactive automated testing and deployment/field troubleshooting, according to one embodiment;

FIG. 4 is a flowchart of a process for interactive automated testing and deployment/field troubleshooting, according to one embodiment;

FIG. 5 is a diagram of a route in an exemplary network between a field NRMS platform and an application, according to one embodiment;

FIGS. 6A-6C are flowcharts of a process associated with troubleshooting field events related to delayed or no response for resource allocation requests, according to one embodiment;

FIG. 7 is a flowchart of a process associated with troubleshooting issues related to unexpected decisions and events associated with the policy based processing of resources allocation request, according to one embodiment;

FIG. 8 is a diagram of a computer system that can be used to implement various exemplary embodiments; and

FIG. 9 is a diagram of a chip set that can be used to implement various exemplary embodiments.

### DESCRIPTION OF THE PREFERRED EMBODIMENT

An apparatus, method, and software for interactive automated testing and deployment/field troubleshooting, is described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

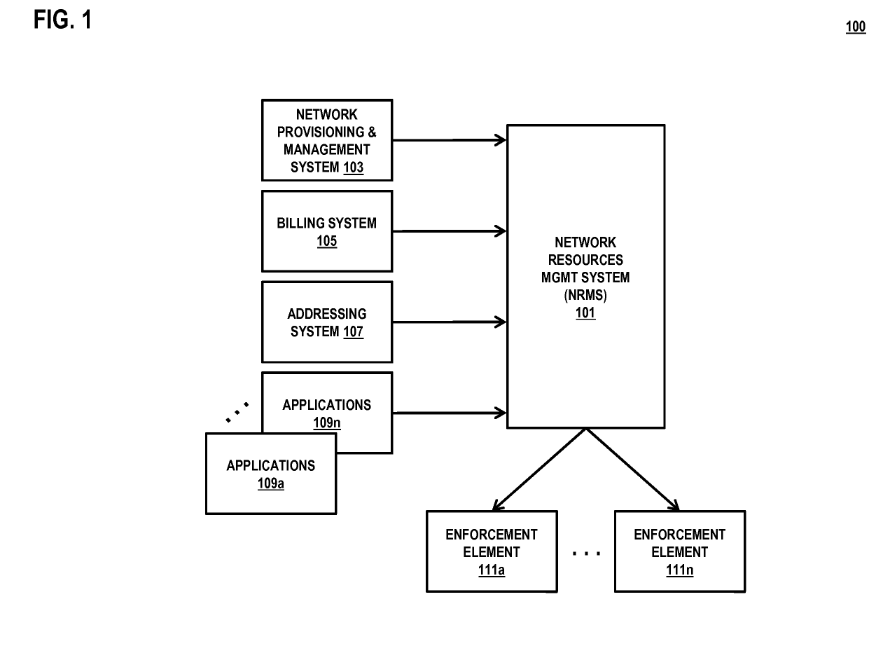

FIG. 1 is a diagram of a network resources management system (NRMS) environment, according to one embodiment. The NRMS system 100 may include the NRMS 101, a Network Provisioning & Management System 103, a billing system 105, an addressing system 107, and applications 109a-109n. The NRMS may also be in communication with enforcement elements 111a-111n. Among many functions, NRMS 100 ensures that the network resources, such as bandwidth, are appropriately allocated according to the corresponding policies and rules. When the NRMS 100 performs its function properly, the end user receives the appropriate quality of service.

In a typical NRMS implementation, the network and its resources are modeled in a manner that allows the NRMS to identify if a new resource allocation request can be accommodated. The NRMS updates its database to reflect the most updated resource allocation status, and provides a response (such as acceptance or rejection) to the application requesting the resource allocation.

An exemplary NRMS deployment cycle involves a test cycle in the lab before the deployment of a new product or a new configuration. The test cases are developed based on the design requirements. Some aspects, such as accurate characterization of transaction loads, may not be known in advance before the actual field deployment. Accordingly, there is a risk that the test may not accurately cover situations that may be seen in the field deployment. Further, a test environment is typically separate from the field environment and managed by a different team within a single service provider. This situation makes it challenging to exchange information to help address existing or potential issues. For example, if a new, dynamic situation starts to occur in the field, such as a particular combination of events with specific timing characteristics, it is likely that the situation will not be detected and identified until the situation causes an undesired behavior impacting customers and causing potential revenue loss.

When an issue is detected in a field environment, further investigation is typically implemented in a lab environment. In traditional systems, configuration and information related to this issue are collected from the field deployment and manually provided to the test team for consideration in the lab environment. Such a process is inefficient for many reasons, including the amount of time the process consumes and the potential need for multiple cycles of data collection and information transfer from the field to the lab environment. Accordingly, it is a challenge to provide useful results in a timely manner such that the impact of the field problem is mitigated as soon as possible, or detect potential events before they start impacting the network performance.

The Network Provisioning and Management System 103 provides information that describes the network and the corresponding resources being managed, such as interconnections and link capacities. The NRMS 101 can create an accurate model of the network based on such information.

The billing system 105 provides information on the type and level of service purchased by a subscriber. Such information is used to identify what resources can be allocated to particular subscribers and when.

The addressing system 107 provides information relevant to the network path on which resources are to be allocated. An example of such information is the current location of a mobile subscriber and the gateway currently serving this user along with the subscriber's IP address. For a wireline subscriber, the information may correspond to the dynamic IP assigned to the subscriber by a dynamic host configuration protocol (DHCP) server, and the corresponding broadband remote access server (BRAS).

In certain embodiments, one or more of the applications 109a-109n may request specific resources from the NRMS 101 to support a request from a particular subscriber. An example can involve a subscriber who requests a certain bandwidth, e.g., 50 megabits per second (Mbps), on demand (BoD) for a predetermined period (e.g., two hours) for a particular application session (e.g., gaming session). Although not illustrated, an application server can generate a resource allocation request to the NRMS 101 identifying the resources being requested. The NRMS 101 processes the request and generates a response to the requesting application identifying the decision, along with other information if applicable. Upon receiving and processing a resource allocation request, the NRMS 101 may also communicate with one or more enforcement elements 111a-111n that can apply a Quality of Service (QoS) policy such that the subscriber traffic is treated according to the service description. The enforcement elements 111a-111n can be a routing/forwarding element, such as a broadband remote access server (BRAS) for wireline services, and a packet data network gateway (PDN-GW) for, e.g., LTE services.

Before being deployed, or upon detecting an error associated with an NRMS, the NRMS may undergo testing. One main objective of the testing process is to verify the compliance of a System Under Test (SUT) as a single element, which in this case is an NRMS, to a set of element requirements. Another main objective is to verify that the end-to-end system functions and performs as expected.

Under certain circumstances, accurate comprehensive requirements may not be available to feed back into the testing. As an example, the arrival patterns of application resource allocation requests may not be known in advance before the field deployment. Similarly, dependency and time intervals between the various events may not be known in advance, and may be dynamic with dependency on factors such as season, subscriber geographic distribution, mobility, world news and media events. Accordingly, the resulting test may not provide a complete coverage for all situations expected in the field deployment.

Testing is typically implemented in a controlled lab environment, and emulation is frequently used to implement some test aspects, such as high signaling load for scale testing, which are more difficult to recreate in the lab using a real end-to-end environment. As an example, a test tool may be used to emulate the transactions associated with high volume of mobile phone users trying to allocate resources for a server-based gaming application. In the field deployment, it is possible that a new software version of the application generating the resource allocation request may exhibit a new, unexpected behavior (such as the form of the messages and/or the sequence of messaging to request the resources). Because the new behavior is not modeled on the emulation-based test tool, the impact of such new behavior will not be considered during the pre-deployment testing, causing a potential impact in the field when this new application is enabled.

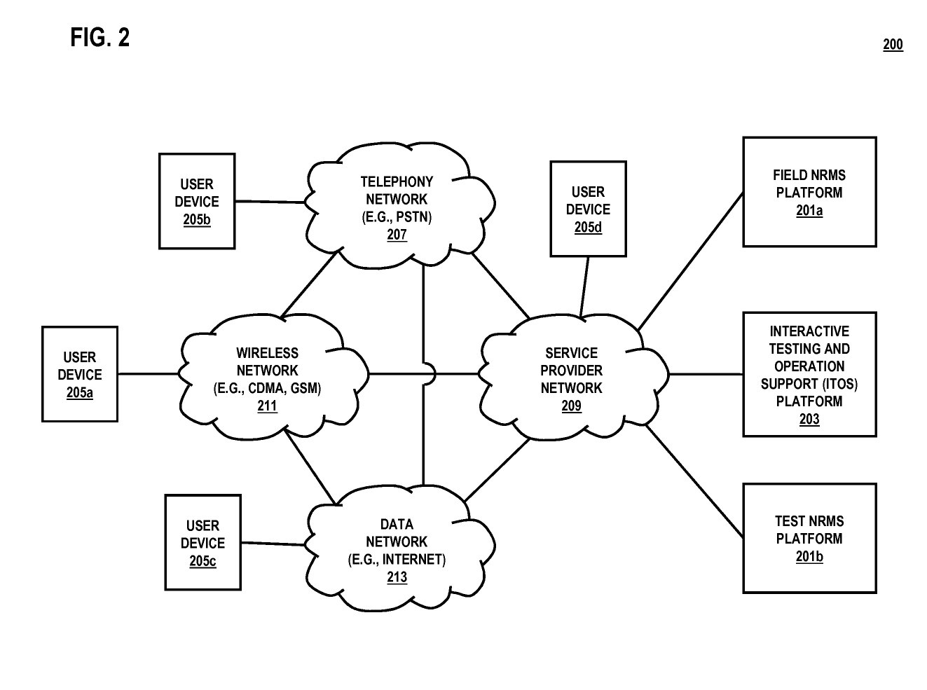

FIG. 2 is a diagram of a system 200 capable of interactive automated testing and deployment/field troubleshooting, according to one embodiment. The approach of the system 200 stems, in part, from the recognition that there is a need to better integrate troubleshooting and optimization between field and test environments, particularly with respect to NRMSs. The interactive testing and operation support (ITOS) platform 203 interfaces with the NRMSs in both the field deployment and lab environments and extracts the appropriate values to use when setting the lab test parameters for automated testing. Accordingly, the ITOS platform 203 enables a service provider to provide reliable network resources management functions even when operating in a dynamic environment. Further, the system 200 provides more support in detecting, troubleshooting, and isolating the root cause of issues and unexpected events observed in the field.

The ITOS platform 203 provides an integrated environment that factors (and thus, can optimize) both the testing and operational aspects of a NRMS, which can provide more accurate test cases that translate to earlier detection of problems before leaking into the field deployment; as well as more capabilities in detecting issues that occur in the field and identifying the corresponding root cause. With the ITOS platform 203, the appropriate mechanisms are introduced such that valuable information is extracted and exchanged simultaneously from and between both a field NRMS deployment and a lab NRMS environment in an efficient manner such that the targeted functional and performance capabilities are achieved.

The ITOS platform 203 interacts with a deployment field environment and dynamically collects information and events that are used to enhance existing test cases and/or develop new test cases. In the system of 200, an exemplary field environment is the field NRMS platform 201a. Further, although only one field NRMS platform 201a is illustrated, the system 200 may include more than one field NRMS platform 201a that may be associated with the same or difference service providers. The ITOS platform 203 can extract information from the field NRMS platform 201a that can identify new characteristics associated with transactions and communications relevant to the field NRMS platform 201a. Further, such new characteristics can be used in some situations as indications of unexpected events that may require intervention to avoid growing into variations that may impact the field.

In one embodiment, the ITOS platform 203, triggered by events in the field, can help in identifying and troubleshooting such issues. The ITOS platform 203 can customize test cases to run in the test environment based on information collected in the field. In the system of 200, an exemplary test environment is the test NRMS platform 201b. The test NRMS platform 201b may include both actual elements and simulated elements such that it can adequately test aspects related to NRMS. This process is highly dynamic and efficient and helps in identifying a root cause and potential workaround. Further, the ITOS platform 203 can be used to influence operational aspects, such as engineering the scalability of an NRMS and other systems and networks, based on the outcome of the implemented troubleshooting and test cases.

As shown, the system 200 includes the ITOS platform 203 implemented as, for example, part of a service provider network 209. However, in alternative embodiments, the ITOS platform 203 could be implemented as any part of the system 200. The service provider network 109 can interact with one or more other networks, such as a telephony network 207, a wireless network 211, and a data network 213.

For illustrative purposes, the networks 207-213 may be any suitable wireline and/or wireless network, and be managed by one or more service providers. For example, telephony network 207 may include a circuit-switched network, such as the public switched telephone network (PSTN), an integrated services digital network (ISDN), a private branch exchange (PBX), or other like network. Wireless network 211 may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 213 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 207-213 may be completely or partially contained within one another, or may embody one or more of the aforementioned infrastructures. For instance, the service provider network 209 may embody circuit-switched and/or packet-switched networks that include facilities to provide for transport of circuit-switched and/or packet-based communications. It is further contemplated that networks 207-213 may include components and facilities to provide for signaling and/or bearer communications between the various components or facilities of system 200. In this manner, networks 207-213 may embody or include portions of a signaling system 7 (SS7) network, or other suitable infrastructure to support control and signaling functions.

According to exemplary embodiments, end user devices (UD) 205a-205d may be utilized to communicate over system 200 and may include any customer premise equipment (CPE) capable of sending and/or receiving information over one or more of networks 205a-205d. For instance, voice terminal may be any suitable plain old telephone service (POTS) device, facsimile machine, etc., whereas mobile device (or terminal) may be any cellular phone, radiophone, satellite phone, smart phone, wireless phone, or any other suitable mobile device, such as a personal digital assistant (PDA), pocket personal computer, tablet, customized hardware, etc. Further, computing device may be any suitable computing device, such as a VoIP phone, skinny client control protocol (SCCP) phone, session initiation protocol (SIP) phone, IP phone, personal computer, softphone, workstation, terminal, server, etc. The user devices 205a-205d may be used by one or more consumers to generate resource allocation requests associated with the service provider network 209 that are directed to the field NRMS platform 201a. The field NRMS platform 201a then processes the resource allocation requests to determine whether the requested resources may be provisioned to the user. The user devices 205 may generate the resource allocation requests directly towards the field NRMS platform 201a, or the user devices 205 may express interest in receiving a particular service from one of the applications 109a-109n, and the applications 109a-109n may generate the resource allocation requests towards the field NRMS platform 201a. As illustrated in FIG. 1, one or more of the applications 109a-109n may be used to generate and/or process the resource allocation requests.

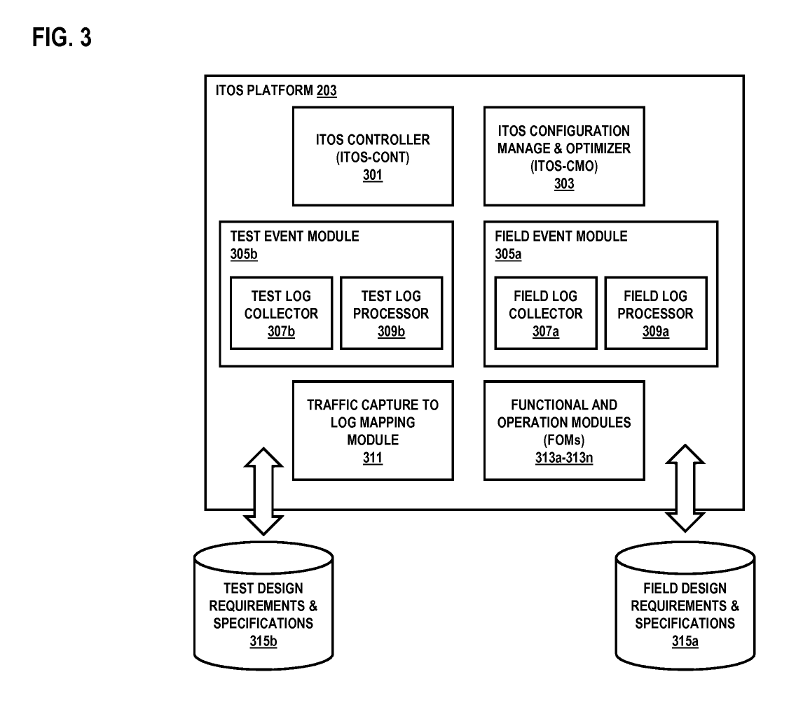

FIG. 3 is a diagram of an interactive testing and operation support (ITOS) platform capable of initiating and performing interactive automated testing and deployment/field troubleshooting, according to one embodiment. As illustrated, the ITOS platform 203 includes an ITOS controller (ITOS-CONT) 301, an ITOS configuration manager and optimizer (ITOS-CMO) 303, field and test event modules 305a and 205b, respectively, a traffic capture to log mapping module 311, and functional and operation modules (FOMs) 313a-313n.

The ITOS-CONT 301 manages and controls the overall operational aspects of the ITOS platform 203. In certain embodiments, the ITOS-CONT 301 identifies criteria to be extracted from a field environment (e.g., the field NRMS platform 201a, in addition to the networks 207-213) and analyzes the information collected and received from the field environment. In certain embodiments, the ITOS-CONT 301 identifies unexpected events and issues in the field environment based on information collected from the field environment. The ITOS-CONT 301 may also influence, directly or indirectly, the configuration of the field environment based on the analysis results from information collected from the field environment and test environment (e.g., the test NRMS platform 201b). In certain embodiments, the ITOS-CONT 301 also identifies test parameters to use in the test environment and test case development, analyzes information collected and received from the test environment, and identifies information to collect or to receive from the test environment. In certain embodiments, the ITOS-CONT 301 also identifies resolution for issues observed in the field environment based on the analysis results from information collected from the field environment and test environment (e.g., the test NRMS platform 201b).

In one embodiment, the elements in the field and test environments, as well as test tools in the test environment, are likely of different brands and from different vendors with potentially different interface and format requirements. In such a scenario, the ITOS platform 203 may include the ITOS-CMO 303 to provide a mediation function. The ITOS-CMO 303 maps the vendor-independent formats used by the ITOS-CONT 301 to the vendor-specific formats needed by the elements and test tools within the system 200. The ITOS-CMO 303 delivers the configuration to both the test configuration manager and field configuration manager (discussed below), and ensures that the configurations are optimized and in the appropriate format. In one embodiment, the ITOS-CMO 303 interacts with a traffic capture to log mapping module 311 to provide configuration related to the capturing and receiving log information. The ITOS-CMO 303 may also interface with the field event module 305a and the test event module 305b to provide management instructions and to receive the log information.

The field event module 305a receives, collects, and processes information related to events relevant to the field NRMS platform 201a in the field environment. In certain embodiments, the field event module 305a includes a field log collector 307a and a field log processor 309a. The field log collector 307a receives and stores event information pertaining to the field environment. The field log collector 307a can receive information using different protocols and/or formats, such as syslog typically from the field NRMS platform 201 and from other elements in the field. The field log collector 307a also may query the field NRMS platform 201a (and/or other elements) for information using protocols such as simple network management protocol (SNMP) or extensible mark-up language (XML). The field log processor 309a processes the information collected by the field log collector 307a from the field NRMS platform 201a. To process this information, the field log processor 309a can apply a set of rules and actions (such as parsing) such that the field log processor 309a extracts only those events and information desired by the ITOS platform 203. Such rules can be identified by the ITOS-CONT 301, and can be transformed to an appropriate format by the ITOS-CMO 303, which sends the formatted rules to the field log processor 309a. Further, the field log processor 309a may analyze collected log events to extract dependency and correlations between the various events. In one embodiment, this analysis process can be guided and/or partially supported by the ITOS-CONT 301.

In certain embodiments, the test event module 305b receives, collects and processes information related to events relevant to the test NRMS platform 201b in the test environment. The test event module 305b can include a test log collector 307b and a test log processor 309b. The test log collector 307b receives and stores event information pertaining to the test environment. The test log collector 307b can receive information using different protocols and/or formats, such as syslog typically from the test NRMS platform 201b and from other elements in the test environment. The test log collector 307b also may query the test NRMS platform 201b (and/or other elements) for information using protocols such as SNMP or XML. The test log processor 309b processes information collected by the test log collector 307b for the test NRMS platform 201b. To process this information, the test log processor 309b can apply a set of rules and actions (such as parsing) such that the test log processor 309b extracts only those events and information desired by the ITOS platform 203. Such rules can be identified by the ITOS-CONT 301, and can be transformed to an appropriate format by the ITOS-CMO 303, which sends the formatted rules to the test log processor 309b. Further, the test log processor 309b may analyze collected log events to extract dependency and correlation between the various events. In one embodiment, this analysis process can be guided and/or partially supported by the ITOS-CONT 301.

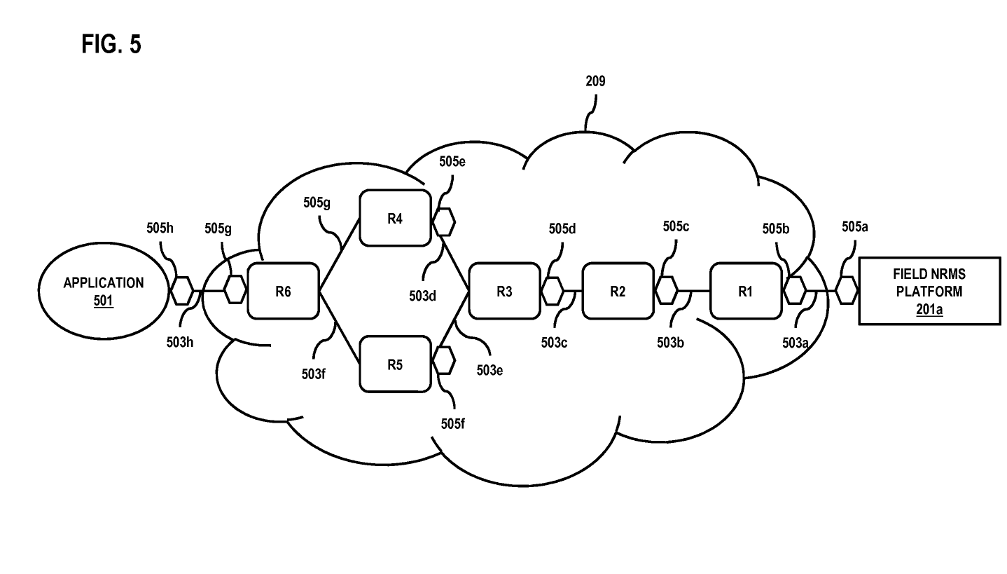

There are some situations where generating a log, or receiving a log, is not possible for various reasons. For example, the field NRMS platform 201a may not provide detailed logs related to the processing of resource allocation requests that can be used to accurately evaluate the corresponding processing time. In such cases, traffic capture can be used to capture the relevant traffic, and then a corresponding log can be generated. Traffic capturing can be performed alone or in combination with a log. For example, some events may be identified through a log, while other events can be identified using traffic capturing. The traffic capture to log mapping module 311 may be implemented in conjunction with one or more of traffic capture devices (as discussed below with respect to FIG. 5) that are strategically located at points within the system 200 where relevant traffic can be monitored without impacting functionality. The traffic capture to log mapping 311 then receives the captured traffic and maps it to the corresponding log message in a format appropriate for processing. The traffic capture to log mapping 311 can manage capture devices in both the field and test environments and the generated logs can be directed to either of the corresponding the field log processor 309a or the test log processor 309b for further processing. To manage the traffic capture process, the ITOS-CONT 301 identifies the needed information, and then the ITOS-CMO 303 identifies the appropriate configuration needed to capture the relevant traffic. Configuration information is then provided to the traffic capture to log mapping 311 to provide to the appropriate capture device.

In one embodiment, the elements of the ITOS platform 203 discussed above can be considered core elements that support and/or enable the overall function of the ITOS platform 203, such as enabling interactive automated parameters collection, testing and field deployment troubleshooting for NRMSs. The above components provide support (for example, control, configuration management, logging and traffic capture) for one or more functional and operational module (FOM) 313a through 313n, which are associated with more specific functionality.

According to some embodiments, FOMs 313a-313n are special purpose modules that utilize the functionality provided by the core ITOS platform 203 elements. The ITOS platform 203 may include any number of FOMs, and the included FOMs may have various functions that interact with the functionality and support of the core ITOS platform 203 elements. In one embodiment, the ITOS platform 203 may include or be associated with three FOMs related to interactive automated testing and to deployment field troubleshooting, such as a FOM 313a for automated optimized performance testing (e.g., FO_AOPT), FOM 313b for automated troubleshooting for delayed or no response to application resource allocations requests (e.g., FOM_TS_Alloc_Req_TimeOut), and FOM 313c for automated troubleshooting for unexpected decisions and events associated with allocation requests (e.g., FOM_TS_Alloc_Req_Err).

As discussed earlier, accurate and comprehensive requirements may not be available before deployment of an NRMS. Accordingly, the exact parameters to use during the testing process may not be available or may not reflect the actual environment that the NRMS will be exposed to. FOM 313a thus extracts information from the field NRMS platform 201a to update the test parameters as a feedback input into the test NRMS platform 201b, all in an automated manner. The collected information can be used to update both the field design requirements and specifications 315a and the test design requirements and specifications 315b.

Although the following providers specific examples of parameters, various parameters listed in the following subsections can be combined, distributed and/or considered partially depending on the applications utilizing the NRMS service, and the corresponding design and implementation aspects. As discussed in more detail below, a subscriber end point and address identification information update transaction may also include information related to the subscriber profile, for example.

In one embodiment, the information by the ITOS platform 203 for automated testing and troubleshooting can be associated with resource allocation requests. Specifically, the collected information can be associated with ensuring that test cases are designed with respect to the test NRMS platform 201b to cover the realistic resource allocation request load characteristics that the field NRMS platform 201a will be subjected to in the field environment.

By way of example, a parameter may describe the maximum number of requests that a system (e.g., the field NRMS platform 201a) may be able to handle in a unit of time, such as one second. For such as parameter, the FOM 313a interacting with the core elements of the ITOS platform 203 may cause the following to occur. The ITOS-CONT 301 may identify an event associated with the parameter when the field NRMS platform 201a receives a resource allocation request for application X as an event of interest. The ITOS-CONT 301 will then instruct the ITOS-CMO 303 to acquire information about the rate of the field NRMS platform 201a receiving resource allocation requests for application X. The ITOS-CONT 301 may specify that it needs to know only about events when this rate exceeds a certain value, such as, for example, 300 requests/sec. Although application X is used as an example, the ITOS-CONT 301 may request the same information for one or more applications 109a-109n.

In one embodiment, the ITOS-CMO 303 then verifies if information associated with this event (receiving a resource allocation) is currently being sent by the field NRMS platform 201a to the field log collector 307a. If sending such information is supported but currently not enabled, the ITOS-CMO 303 can communicate with the field NRMS platform 201a to provision it such that this event notification is sent to the field log collector 307a. In one embodiment, such provisioning may occur through a field configuration manager (not shown) within the field NRMS platform 201a instructing it to provision the field NRMS platform 201a accordingly. Such a provisioning message may be, for example, LOG (Event=Receive_Request AND Source_Application=Application X) TO IP_Address of Field Log Collector 307a.

In one embodiment, if the ITOS-CMO 303 identifies that generating log information from the field NRMS platform 201a is not supported, then traffic capturing can be used instead to collect the information. In this case, the ITOS-CMO 303 can provision the traffic capture to log mapping module 311 to provision the appropriate capture devices.

Subsequently, the ITOS-CMO 303 can provision the field log processor 309a to extract the required log events on the desired time intervals. Further, the ITOS-CMO 303 can instruct the field log processor about the desired scheme to handle the information. Examples of such schemes are, for example, the field log processor 309a informs the ITOS-CONT 301 that the information is available for retrieval; the field log processor 309a forwards the information to the ITOS-CONT 301 as soon as the information is available; or the field log processor 309a applies data processing operations (such as statistical processing) and informs the ITOS-CONT 301 only when the statistical processing results indicate exceeding a threshold that has been identified in advance.

Subsequently, the ITOS-CONT 301 analyzes the data, and extracts the observed maximum rate of resource allocation request. If the extracted value suggests the need to modify the test environment (for example, changing the maximum rate of resource allocation request used in testing from 300 to 450 requests per second), the information is sent to both the field design requirements and specifications 315a and the test design requirements and specifications 315b. In one embodiment, the information can also be sent also to a test configuration manager (not shown) associated with the test NRMS platform 201b to modify the procedure in the appropriate test case to use the higher maximum rate of resource allocation request.

In one embodiment, although the resource allocation requests can be within the maximum rate, a number of requests may arrive together creating a burst of requests that may exceed the maximum rate for a short period of time (such as a fraction of a second). This pattern may stress an NRMS and, accordingly, this case can be captured and included in the testing.

The burstness of the allocation request traffic can be described by identifying the burst rate and the burst size. For example, a burst rate of 1000 requests per second and a burst size of 0.25 seconds can be used to describe the burstness characteristics that the field NRMS platform 201a is exposed to. A parameter associated with the burstness can be evaluated according to the following. The ITOS-CONT 301 can identify an event when the field NRMS platform 201a receives a resource allocation request for application X as an event of interest. The ITOS-CONT 301 can then instruct the ITOS-CMO 303 that it needs to know about the burstness of received resource allocation requests for application X at the field NRMS platform 201a. The ITOS-CONT 301 may specify that it needs to know only about events when the burst rate or burst size exceeds certain values. Although application X is used as an example, the ITOS-CONT 301 may request the same information for one or more applications.

In one embodiment, the ITOS-CMO 303 then verifies whether information associated with this event (receiving resource allocation) is currently being sent by the field NRMS platform 201a to the field log collector 307a. If sending such information is supported but currently not enabled, the ITOS-CMO 303 can communicate with the field NRMS platform 201a to provision it such that this event notification is sent to the field log collector 307a. In one embodiment, such provisioning may occur through a field configuration manager (not shown) within the field NRMS platform 201a instructing it to provision the field NRMS platform 201a accordingly.

In one embodiment, if the ITOS-CMO 303 identifies that generating log information from the field NRMS platform 201a is not supported, then traffic capturing can be used instead to collect the information. In this case, the ITOS-CMO 303 provisions the traffic capture to log mapping module 311 to provision the appropriate capture device.

Subsequently, the ITOS-CMO 303 can provision the field log processor 309a to extract the required log events on the desired time intervals. Further, the ITOS-CMO 303, based on instructions from the ITOS-CONT 301, instructs the field log processor 309a about the desired scheme to handle the information, such as the schemes listed above. The ITOS-CONT 301 can then analyze the data and extract the observed burst rate and burst size. If the extracted value suggests the need to modify the test environment (for example changing the burst size from 0.25 to 0.35 seconds), the information is sent to both the field design requirements and specifications 315a and the test design requirements and specifications 315b to update both configurations of both the field NRMS platform 201a and the test NRMS platform 201b. In one embodiment, the information can also be sent to a test configuration manager (not shown) associated with the test NRMS platform 201b to modify the procedure in the appropriate test case to use the higher maximum rate of resource allocation request.

In one embodiment, parameters may be associated with evaluating subscriber endpoint identification transaction load characteristics. As discussed above, the subscriber end point identification information is communicated to the field NRMS platform 201a such that it has information related to the subscriber such as his or her current IP address and/or location. The subscriber end point identification information can be used by the field NRMS platform 201a to identify the network path or segments over which it needs to allocate the resources. Further, the subscriber end point identification information may be used to identify the specific quality of service assigned for this subscriber in his current location. In order to ensure that test cases are developed to cover a realistic subscriber end point transaction load which the field NRMS platform 201a will be subjected to in the field, the ITOS-CONT 301 can identify, for example, the following characteristics: the maximum rate of subscriber end point transactions; and subscriber end point transaction burstness characteristics (e.g., burst rate and burst size). These parameters can be collected using a scheme similar to the one described above for allocation requests.

In one embodiment, parameters may be related to topology information transaction characteristics. Topology information is used by the field NRMS platform 201a such that it can model the network over which resources are allocated. The rate of such transactions is expected to be relatively small, under normal circumstances. In certain embodiments, the ITOS-CONT 301 is typically interested in receiving information from the field NRMS platform 201a if there is an indication that the topology information transaction in the field is exhibiting new characteristics that may potentially have an impact on the system performance. In one embodiment, topology transactions are associated with additional processing by the field NRMS platform 201a, such as a single topology transaction deleting a single element being associated with the removal of numerous (e.g., hundreds) sub-interfaces and objects associated with these elements.

Parameters related to topology information transaction characteristics that may be captured are, for example, topology transaction maximum rate; topology transaction burst rate and burst size; and topology transaction maximum size for each transaction type, object and sub-object, where transaction type includes create, delete and update and an example of the parameters is [Transaction Type=“Create”, Transaction Object=“Router”, Object Size=“3”, Transaction Sub-Object=“Interface”, Sub-Object Size=40]. Capturing and evaluating such details allows the ITOS platform 203 to capture and evaluate the realistic characteristics that may affect load aspects other than the transaction rate.

In one embodiment, parameters may be related to subscriber profile information transactions characteristics. A subscriber profile provides information regarding the type, quality, amount, and duration of resources that can be allocated to a particular subscriber. For example, a subscriber may subscribe to a service where he or she receives the highest speed when using LTE technology between 6:00 and 9:00 PM, and a slower speed otherwise. The rate associated with this type of transactions is relatively low, but some applications may be characterized by higher and more dynamic rates (such as in the case of applications available for mobile users). Examples of parameters that may be captured associated with subscriber profile information traffic characteristics include subscriber profile transaction maximum rates and subscriber transaction burst rate and burst size.

In one embodiment, parameters may be associated with patterns of events. For example, although the field NRMS platform 201a may perform as expected as long as each individual input component is within its maximum expected rate/load, the combination of simultaneous specific inputs and/or events may expose the field NRMS platform 201a to a situation where it may deviate from the expected performance. The ITOS-CONT 301 can collect information that captures such a combination of events, and the corresponding characteristics, that the field NRMS platform 201a can be exposed to. The ITOS-CONT 301 collects information on the association between a set of events and the possibility that those events can occur simultaneously, with some overlap or with some correlation. Further, if two or more events are identified as candidates, additional information such as load characteristics and timing information is collected. Examples of events to consider include resource allocation requests; subscriber endpoint identification transactions; topology information transactions; subscriber profile transactions; NRMS local high availability events (such as a module failovers); NRMS remote high availability events (such as the failover of neighboring network elements); NRMS local maintenance events (such as database synchronization, local backup); NRMS remote maintenance events (such as remote backup, remote file transfer); and modeled network topology events (such as a failure in the modeled network where resources are allocated).

Identifying potential dependency and degree of correlation can be accomplished by analyzing the collected event logs by the field log processor 309a and/or support from the ITOS-CONT 301. An example of an identified association can be illustrated as follows. Analyzing the log events reveals the occurrence of Event 1 (e.g., the occurrence of a topology information transaction of type “create” for network element type “Subscriber Aggregation Router”) followed within two seconds with Event 2 (e.g., local configuration verification and synchronization) and then, after 3 more seconds, with Event 3 (e.g., receiving a large number of subscriber end point transactions, such as 20,000). Event 3 may take 45 seconds to complete, with a maximum transaction rate of 2000 per second.

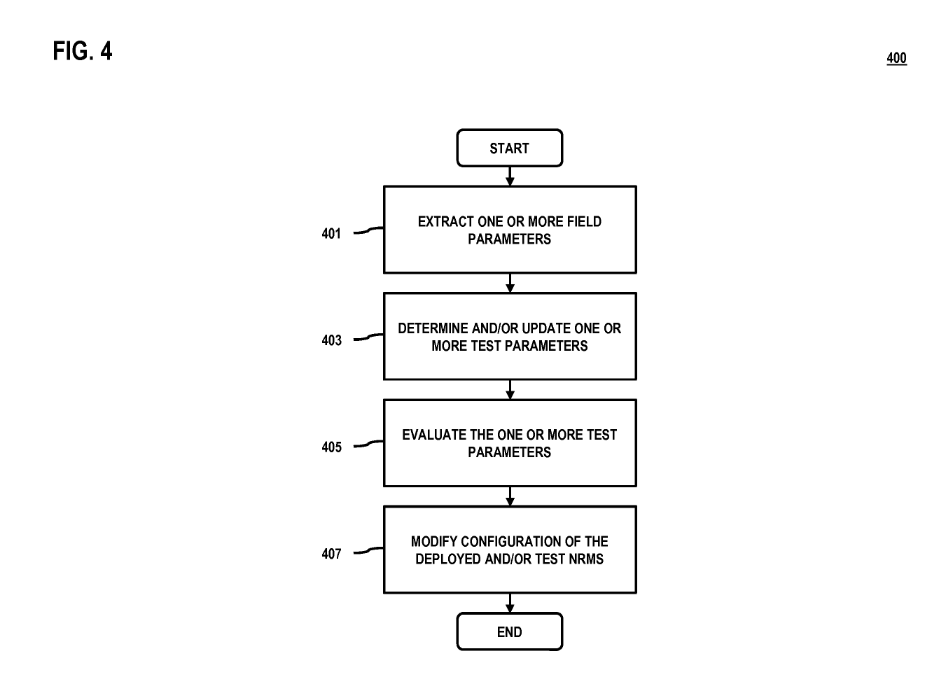

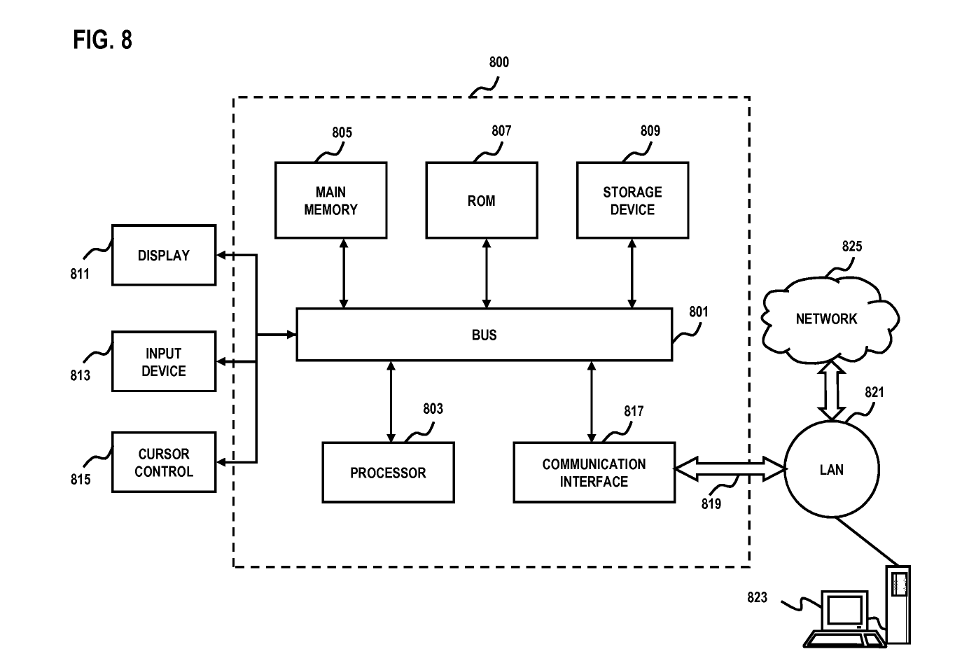

FIG. 4 is a flowchart of a process 400 for interactive automated testing and deployment/field troubleshooting, according to one embodiment. In one embodiment, the ITOS platform 203 performs the process 400 and is implemented in, for instance, a chip set including a processor and a memory as shown in FIG. 8. As discussed above, the ITOS platform 203's core components may, in one embodiment, by instructed to perform the process 400 according to an FOM (e.g., FOM 313a).

At step 401, the ITOS platform 203 extracts one or more field parameters associated with the field NRMS platform 201a. By way of example, the extraction may occur after the ITOS-CONT 301 identifies an event according to when the field NRMS platform 201a receives a resource allocation request for application X as an event of interest and needs to know about the rate the field NRMS platform 201a receives resource allocation requests for application X. The one or more field parameters may be extracted from one or more logs associated with the field NRMS platform 201a, or may be acquired based on being captured within traffic associated with the NRMS platform 201a.

At step 403, the ITOS platform 203 determines and/or updates one or more test parameters associated with test NRMS platform 201. The one or more test parameters may be determined and/or updated from the field and/or test design requirements and specifications 315a and 315b, respectively, or may be determined and/or updated directly from the parameters received from the field environment. The one or more test parameters may also be associated with specific tests that are setup for execution at the test NRMS platform 201b. Determining and/or updating may also include determining and/or updating test cases. Thus, in one embodiment, test cases may be determined at step 403.

At step 405, the ITOS platform 203 inputs the determined and/or updated test parameters within the test NRMS platform 201b to evaluate the one or more test parameters. The one or more parameters may be pushed to the test NRMS platform 201b with one or more test cases that were updated and/or created based on the test parameters. In one embodiment, the test NRMS platform 201b may receive the test parameters and/or test cases via a test configuration manager (not shown). In one embodiment, where the network elements differ, for example, between the field NRMS platform 201a and the test NRMS platform 201b, the ITOS-CMO 303 may map the new test cases to vendor-dependent formats, from vendor-independent formats at the ITOS platform 203, and push the test cases to the test NRMS platform 201b. Once the test NRMS platform 201b receives the test parameters and/or test cases, the test NRMS platform 201b evaluates the test parameters and/or test cases.

At step 407, after the test NRMS platform 201b evaluates the test parameters and/or test cases, the test NRMS platform 201b sends the information back to the ITOS platform 203. By way of example, the information may be received at the ITOS-CONT 301. Accordingly, the ITOS platform 203, such as performed by the ITOS-CONT 301, modifies a configuration of the field NRMS platform 201a. By way of example, the ITOS-CONT 301 may update, as needed, the field design requirements and specifications 315a. In one embodiment, the ITOS-CONT 301 may also modify a configuration of the test NRMS platform 201b. By way of example, the ITOS-CONT 301 may update, as needed, the test design requirements and specifications 315b associated with the test NRMS platform 201b. According to the foregoing, the ITOS platform 203 may automatically optimize the configuration of the field NRMS platform 201a upon the occurrence of one or more triggering events without the need for operator action by extracting information from the field and testing conditions related to the information at a test environment. The information can be used further to update the test environment and the field environment.

By way of another example with respect to the FOM 313a-313c, FOM 313b can be, for example, for automated troubleshooting, root cause analysis and trouble replication of issues related to delayed or no response to application resource allocation requests. For a typical service, the team responsible for the operational aspects has visibility of configuration and log events associated with the system/service which the team is responsible for. The elements and systems in the field are considered critical and, accordingly, performing test activities to support troubleshooting is typically not allowed to avoid potential service impact events. Further, the field environment lacks the flexibility associated with the lab environment that allows the implementation of fine tuned test cases in a controlled environment. FOM 313b can be used to cause the ITOS platform 203 to provide for both on-demand and automated trouble shooting and problem root cause identification.

When an application sends a resource allocation request to the field NRMS platform 201a, a response message from the field NRMS platform 201a (allowing or denying the allocation request) is expected within a certain amount of time. If the response is not received within this expected amount of time, this situation is considered as an unexpected event, which has a negative impact on the customer experiences tied to the field NRMS platform 201a (and potential revenue loss for the service provider). To address such events, the FOM 313b can cause the ITOS platform 203 to implement the following tasks: identify the response time (or confirm a no response condition) associated with the unexpected event; capture the environment parameters during a window of time (configurable duration) around the unexpected event; perform analysis to identify (or limit the search domain for) the root cause behind the response time issue; replicate environment and procedure in the test environment to confirm analysis result and if the issue can be replicated on-demand; and, if applicable, in case where a design aspect can be manipulated trying work around the impact of the issue, one or more iterations of experimenting with modified environment parameters may be implemented.

When investigating issues related to delayed response time, the end-to-end response time can be looked at as two main components. The first component is the processing time associated with the field NRMS platform 201a (e.g., time period from when the field NRMS platform 201a receives the resource allocation request until it generates the corresponding resource allocation response). The second component is composed of the message transport delay, which is the aggregation of the time needed to transport the resource allocation request from the entity which generated the resource allocation request (e.g., an application 109) to the field NRMS platform 201a, and the time to transport the response back from the field NRMS platform 201a to the application. Accordingly, the relationship between the response time and its components can be formulated as follows:

End-to-end response time=NRMS (e.g., field NRMS platform 201a) processing time+allocation request transport time+allocation response transport time.

The network and individual elements are typically designed and engineered such that the contribution of individual components towards the response time does not exceed a predetermined value. When one or more of those components exceeds the expected value, the end-to-end response time may exceed its acceptable value leading to the unexpected event. The following are a number of exemplary mechanisms that can be used by the ITOS platform 203 according to the FOM 313b to collect information related to processing time and propagation time components. These measurements are collected and analyzed, depending on the case under consideration, in a manner that supports troubleshooting and root cause analysis.

In one embodiment, one or more parameters for the testing may be associated with identification of processing time when log capability is available. In such an embodiment, the field NRMS platform 201a is capable of generating log messages to the field event module 305a. These log messages identify, or include sufficient information to identify the request processing time. In one embodiment, the field NRMS platform 201a has the appropriate process that associates the events of receiving an allocation request and sending an allocation response with corresponding time stamps, as follows: an incoming time stamp indicating the time when the field NRMS platform 201a first receives an allocation request and an outgoing time stamp indicating the time when the field NRMS platform 201a finishes processing the allocation request, and the response is sent out. By way of example, the events may correspond to the following log events:

(1) Log event code 1095: NRMS ID 192.170.100.100 received Allocation Request from application ID 1047 at IP 192.171.1 with session ID 10002357 on Jul. 10, 2012 08:20:15.010
(2) Log event code 1096: NRMS ID 192.170.100.100 sent Allocation Response to application ID 1047 at IP 192.171.1 for session ID 10002357 on Jul. 10, 2012 08:20:16.017

In at least one embodiment, the log format includes sufficient information such that the field log processor 309a can extract the response time. The captured traffic received by the traffic capture to log mapping module 311 may not be pre-correlated (e.g., the request is not yet paired with its corresponding response). To accomplish this correlation, the field log collector 307a can forward the log received from the field NRMS platform 201a to the field log processor 309a. To correlate a resource allocation response with its corresponding request, the field log processor 309a can parse the log using a correlation descriptor. This correlation descriptor can depend on the formats of the logs. By way of example, the correlation rule can be described as follows: given a Resource Allocation Request X and a Resource Allocation Response Y, the Resource Allocation Response Y corresponds to Resource Allocation Request X if the following conditions are met: sending Application ID in X=Receiving Application ID in Y; and sending NRMS ID in Y=Receiving NRMS ID in X; and Application IP address in X=Application IP address in Y; and Session ID in X=Session ID in Y. After a resource allocation response is associated with its corresponding request, the processing time is calculated based on the time stamps as follows: Resource Allocation Processing Time=time stamp associated with the response—time stamp associated with the request. In the above example, processing time=1.007 seconds (Jul. 10, 2012 08:20:16.017-Jul. 10, 2012 08:20:15.010).

If log capability on the field NRMS platform 201a is not available or not preferred, an alternative mechanism based on traffic capture can be used to identify the processing time of an allocation request. To identify the processing time, the ITOS platform 203 can capture and time stamp the request and the corresponding response. This arrangement requires having access to an appropriate collection point. In one embodiment, traffic is captured at the closest point to the network interface of the field NRMS platform 201a where the allocation requests are received and responses are sent.

Considering that this traffic capture is implemented with a particular scope, it is typically more efficient to capture only the relevant traffic. Accordingly, in one embodiment, the ITOS-CONT 301 can instruct the ITOS-CMO 303 about the scope of traffic to capture. This scope can be described as allocation requests and responses exchanged between a specific application (e.g., application ID 1047 at IP 192.171.1) and the field NRMS platform 201a (e.g., ID 192.170.100.100). The ITOS-CMO 303 generates the appropriate vendor-specific configuration and sends it to the traffic capture to log mapping module 311, which in turn ensures that the capture devices are provisioned appropriately to capture the desired scope of traffic.

After capturing the traffic, the capture device forwards the time-stamped captured traffic to the traffic capture to log mapping module 311. The mapping function intercepts the traffic and maps it to the appropriate log format. The log format can include sufficient information such that the field log processor 309a can extract the response time. In particular, the traffic capture to log mapping module 311 can insert the time stamp as provided in the captured request and response. The traffic capture to log mapping module 311 may select to change the format by which the time stamp is represented (for example, the traffic capture to log mapping module 311 may map the time stamp from MM/DD/YY HH:MM:SS.SSS format to the Epoch format, and vise versa).

A second point is that the traffic capture to log mapping module 311 may need to parse the internal fields of the received captured packet, such that it can construct appropriate log messages with sufficient information such that the field log processor 309a can correlate a response to its corresponding request. This point can be further illustrated using the following examples for captured messages, where XML is used as protocol to send/receive the request/response.

Resource Allocation Request example
<?xml version=“1.0” encoding=“UTF-8”?>
<XmlInterfaceRequest>
<ResourceAllocationRequest>
<ApplicationID>1047</ApplicationID>
<RequestClientIP>192.168.1.1</RequestClientIP>
<SessionID>10002357</SessionID>
<ReqBandwidth>3000000</ReqBandwidth>
<SubscriberIP>192.169.1.1</SubscriberIP>
</ResourceAllocationRequest >
</XmlInterfaceRequest>
Resource Allocation Response example
<?xml version=“1.0” encoding=“UTF-8”?>
<XmlInterfaceRequest>
<ResourceAllocationResponse>
<ApplicationID>1047</ApplicationID>
<RequestClientIP>192.168.1.1</RequestClientIP>
<SessionID>10002357</SessionID>
<GrantedBandwidth>3000000</GrantedBandwidth>
<ResponseValue>TRUE</ResponseValue>
</ResourceAllocationResponse>
</XmlInterfaceRequest>

The traffic capture to log mapping module 311 can then parse the XML tags embedded in each packet, extract relevant information, and package it in the log message, along with the appropriate time stamp. Once the logs have been generated by the traffic capture to log mapping module 311 and forwarded to the field log collector 307a and then to field log processor 309a, the information can be correlated and processed as discussed above to identify the processing delay for the request/response pair.

In one embodiment, one or more parameters may be analyzed for identifying transport delay at different network points using traffic capture capabilities. The purpose of measuring the contribution of the different segments of the network into the overall transport delay, and hence into the end-to-end response time, is to enable the identification of the source of the problem, and reduce the scope of the domain where to look for the problem. Each network segment is engineered to contribute an amount of delay that does not exceed a specific value. When the delay of a network segment exceeds the maximum value identified the design, it is considered an unexpected event, with a potential impact on the service and can cause problems. Traffic can be captured at different points by placing traffic capture devices at the desired points. Those points are typically strategically selected such that maximum benefits are obtained with minimal cost.

FIG. 5 illustrates an environment associated with, for example, the service provider network 209 and the field NRMS platform 201a where an application 501 sends a resource allocation request, and the field NRMS platform 201a generates a corresponding response. By way of example, the application 501 may be one of a plurality of applications executed at a user device 205 and/or may be one of the applications 109a-109n illustrated and discussed with respect to FIG. 1. Both the request and the response travel a route through routing elements R1-R6 connected by links 503a through 503h. As illustrated, the routing elements R1-R6 may be within the service provider network 209. However, the routing elements R1-R6 may be associated with any communications network, such as the networks 207-213 illustrated in FIG. 2. In the illustrated example, the transport delay between two points refers to the summation of transport delay over the links between those two points, and the routing delay associated with forwarding through the routing element (or elements) between those two points. To evaluate the transport delay components for the different network segments, traffic is captured at multiple points. The process of capturing and analyzing the traffic can occur as discussed above with the traffic associated with the allocation request and response being captured and tracked at multiple points. Considering the exemplary network illustrated in FIG. 5, the traffic can be captured at one or more of the traffic capture devices 505a through 505h associated with the links 503a through 503h and between the routing elements R1 through R6.

The ITOS CONT 301 may need to analyze collected information to support the troubleshooting process. Within the context of troubleshooting issues related to the deviation from the expected end-to-end delay or in the case of no response at all, the objective is to identify the offending link or routing element and provide additional information such as the magnitude of the deviation. Depending on the network topology, the number and location traffic capture devices 505a through 505h, the ITOS platform 203 may only be able to narrow down the offending object to a set of routing elements and links versus being able to determine a specific element or link. The analysis relies on compiling collected delay related information, then comparing against the requirements/specifications.

In the case when no response is received by the application 501, the ITOS platform 203 tries to identify the link or the routing element where this specific response was last seen. This can be accomplished by parsing the log associated with the capture at the different traffic capture devices 505a through 505h. The ITOS-CONT 301 can instruct the ITOS-CMO 303 to consider the search using one or a combination of the following approaches: start the search for the response for a session ID at the log for traffic capture devices 505a-505h starting from a response entry point into the service provider network 209. In this case, the log for capture traffic associated with 505a is searched first, then point 505b, then 505c, and so on. If the response for a session ID is not found in the log for a traffic capture point, then the previous point is identified where the response is last seen. For example, if a response for the session ID under consideration was found in the log for traffic capture device 505b, but not in the log capture of 505c, then the network element(s) between those two points, namely R1, is considered as a potential element where the response was lost or dropped.

After identifying a potential cause and probable element behind the delayed or absent response, the ITOS platform 203 via the ITOS-CONT 301 may decide to implement one or more test cases to confirm the conclusion. To achieve an accurate verification, there is a need to run this test in an environment that is close as possible to the field setup. The ITOS-CONT 301 manages a process to collect the needed information from the field and then use it in setting up the test environment, as discussed below.

After the analysis process is completed, the following possibilities exist. First, the analysis may have revealed that one routing element or a subset of routing elements, and/or one link or a subset of links are labeled as the probable cause of (or contributing to) the problem. Second, the analysis may be unable to identify any routing element or link as the cause of the problem. For example, this can be the case when the system fails to receive information from a local traffic capture device due to a local trouble with the traffic capture device. In either case, the ITOS platform 203 may still replicate the problem that has been observed with respect to the field NRMS platform 201a in the more controllable lab environment with respect to the test NRMS platform 201b. The replication in the lab environment helps with the following: gain more information on the scope and characteristics of the problem, such as the conditions that may trigger/contribute to its presence, and ability to experiment with a potential fix for the problem or a work around.

Before replicating the environment, the parameters that describe the field environment when the problem is experienced are determined. When the ITOS-CONT 301 identifies that a capture of field parameters is needed, there is a need to setup the system such that those parameters are captured at the appropriate time. In one embodiment, this is the time interval that covers the time before the start of the problem, and ends after the occurrence of the problem. Considering that the problem may not be frequent, and that systems have a finite capacity to store information, the following approach may be considered. The ITOS platform 203 may be provisioned with the number of capture instances needed before the problem occurrence (NB), and the number of capture instances needed after the problem occurrence (NA). The ITOS-CONT 301 can also identify the frequency by which the environment descriptors are captured. By way of example, the field NRMS platform 201a is instructed to capture environment descriptors every hour, and to save 10 environment descriptors captures before the problem occurrence (NB=10), and to save 5 environment descriptors captures after the problem occurrence (NA=5). The field NRMS platform 201a deletes extra captures, such that only 10 descriptor captures are kept (those most recent which occur before the problem occurrence). Five descriptor captures are collected after the problem occurrence to conclude the collection process. The captured information is analyzed by the ITOS-CONT 301 such that useful information is extracted and used when provisioning the lab emulation environment associated with the test NRMS platform 201b when trying to replicate the problem.

As discussed above, environment parameters to capture may include, for example, parameters directly related to the field NRMS platform 201a, such as the parameters that describe inputs, conditions and transactions directly associated with the field NRMS platform 201a, which may include maximum rate of resource allocation request; resource allocation request burstness (burst rate and burst size), maximum rate of subscriber end point transaction, subscriber end point transactions burstness characteristics (burst rate and burst size), topology transaction maximum rate, topology transaction burst rate and burst size, topology transaction maximum size for each transaction type (e.g., create, delete and update), object and sub-object, subscriber profile transaction maximum rate, and subscriber transaction burst rate and burst size. Other parameters that are not directly related to the field NRMS platform 201a may also be captured and include, for example, parameters that have a potential impact on the functional and/or performance aspects of the field NRMS platform 201a, such as the traffic load on an intermediate communication link on the path between the field NRMS platform 201a and an application server.

After collecting, analyzing and extracting the corresponding parameters associated with the field NRMS platform 201a, the ITOS-CONT 301 instructs the ITOS-CMO 303 to generate one or more test configuration profiles. Typically, the intention of the first profile is to verify the ability to recreate the problem using an environment that is close as possible to the configuration of the field NRMS platform 201a. Accordingly, minimum or no changes are made relative to the descriptors collected from the field. Other profiles may be created to verify the sensitivity of the problem to the different parameters (e.g., the impact of changing parameters on the ability to recreate the problem, or the magnitude and characteristics of the problem). The ITOS-CMO 303 schedules the test cycles using the corresponding profiles, and results are provided to the ITOS-CONT 301. The ITOS-CONT 301 can then compile a report that can be used to provide valuable information regarding the problem.

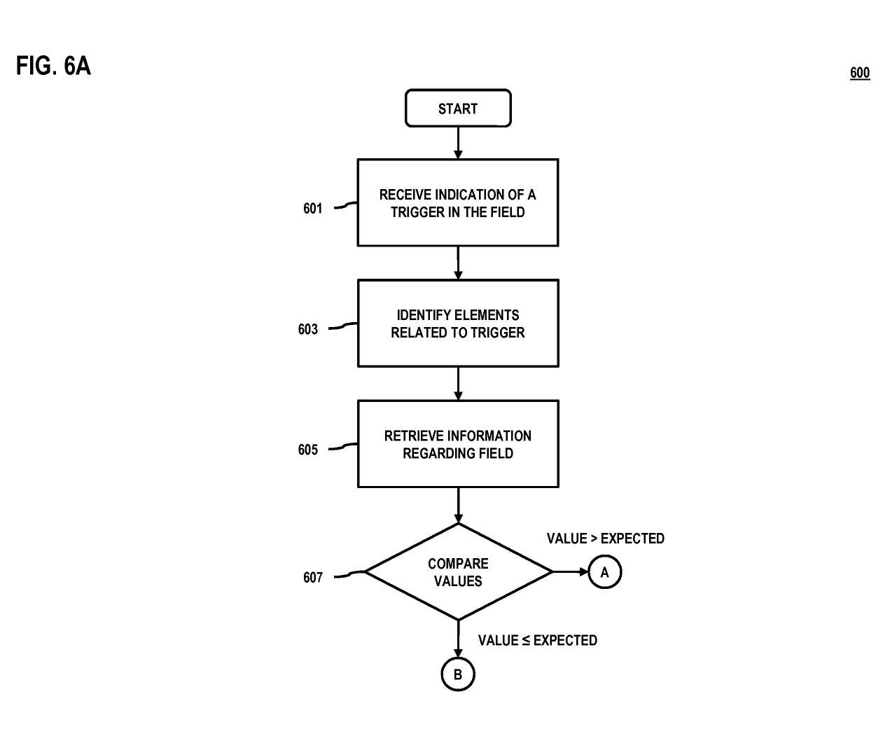

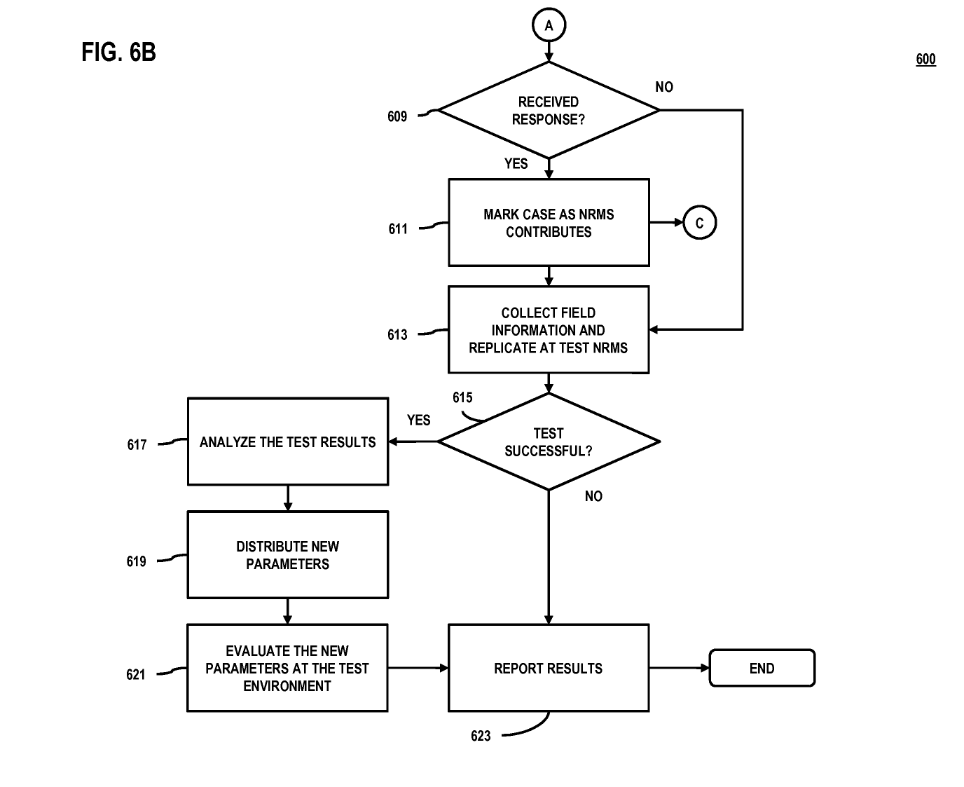

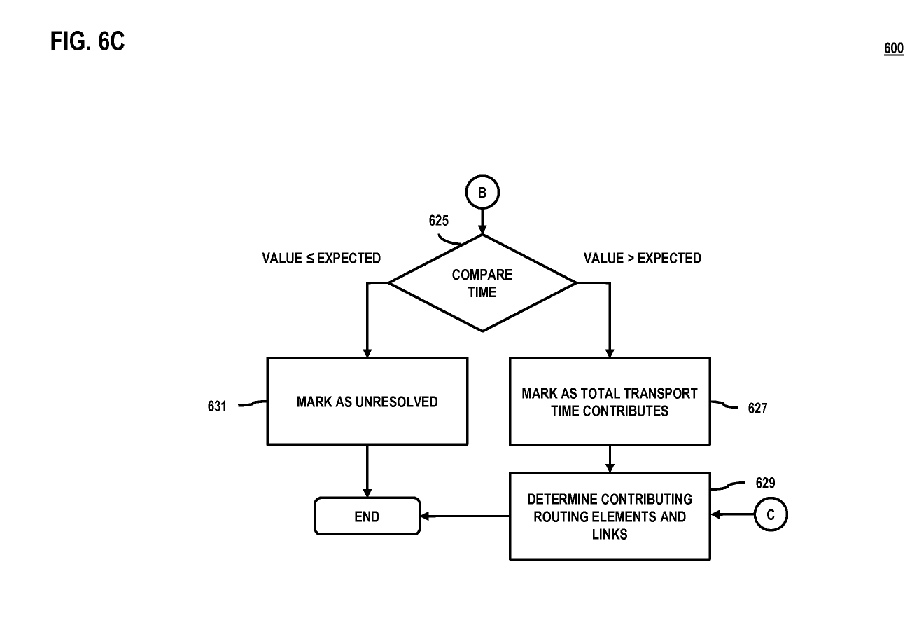

FIG. 6A-6C are flowcharts of a process 600 for troubleshooting field events related to delayed or no response for resource allocation requests, according to one embodiment. In one embodiment, the ITOS platform 203 performs the process 600 and is implemented in, for instance, a chip set including a processor and a memory as shown in FIG. 8. As discussed above, the ITOS platform 203's core components may, in one embodiment, by instructed to perform the process 600 according to an FOM (e.g., FOM 313b).

As shown in FIG. 6A, at step 601, the ITOS platform 203 via the ITOS-CONT 301 receives an indication (e.g., trigger) of a response time issue in the field environment associated with an application. For example, if a video conferencing application detects that its resource allocation request for bandwidth has not been responded to within 5 seconds of sending the request, a notification is sent to the ITOS-CONT 301 associated with the relevant NRMS (e.g., field NRMS platform 201a) informing about the event. One example of such a notification is through a syslog message according to: Code: 3478 Resource Allocation Request Timeout Notification: Application Video Net Conference ABC, Node ID 3499 at IP address 192.168.1.1 has not received a resource allocation response from NRMS ID 2266 at IP address 192.168.5.1 within the maximum allowed time interval 5 seconds. Request ID 10002357 for subscriber ID ABCD-1234567. The ITOS-CONT 301 intercepts the notification and identifies that it is appropriate to process it further (for example, coming from an authorized application). The ITOS-CONT 301 confirms that the event indicated in the log(for example, based on the message code and/or some of the other information) needs to be handled based on a response time troubleshooting mode according to FOM 313b.

At step 603, based on the information received in the notification of the event, the ITOS-CONT 301 identifies the field NRMS platform 201a, routing elements and links that are relevant to the event. By way of example, the notification message may include NRMS ID 2266 and an IP address of 192.168.5.1 that identifies the NRMS involved in this unexpected event. By way of example, the message may also include the application information of “Application Video Net Conference ABC, Node ID 3499 at IP address 192.168.1.1” to identify the application that generated the resource allocation request. In addition, the ITOS-CONT 301 can also identify routing elements associated with the path where the resources need to be allocated if the allocation request was to be granted (e.g., topology/allocation information). To accomplish this, the ITOS-CONT 301 instructs the ITOS-CMO 303 to query the field NRMS platform 201a (e.g., a field configuration manager associated with the field NRMS platform 201a) requesting topology/allocation ID and subscriber ID “Request ID 10002357 for subscriber ID ABCD-1234567.”

At step 605, the ITOS-CONT 301 retrieves information from the field design and requirements specifications 315a for processing and transport time for relevant routing elements and links. The information is used to identify the accepted values and thresholds for processing time for the field NRMS platform 201a, and the transport delay associated with the relevant links and routing devices. For example, if the field design requirements and specifications 315a indicates that a maximum processing time for the field NRMS platform 201a when processing an allocation request is 7 seconds, then there is a potential that the event associated with the notification may indeed be within the expected behavior scope, and that the event log from the application may indicate that the application has a tighter expectation regarding the response time. Thus, the ITOS-CONT 301 starts a process with the objective of identifying the field NRMS platform 201a's processing time and the total transport time.

At step 607, upon receiving the results, the ITOS-CONT 301 compares the measured value of the processing time to the corresponding value in the field design requirements and specifications 315a. If the measured value exceeds the expected value, the process 600 proceeds to the step 609 (FIG. 6B). If the measured value is equal or less relative the expected value, the process proceeds to step 625 (FIG. 6C).

Adverting to FIG. 6B, at step 609, if there is a received response, the process 600 proceeds to step 611. If not, this case is labeled as a missing response case, and the process 600 proceeds to step 613.

At step 611, the ITOS-CONT 301 marks this case as “NRMS processing time contributes to the delayed response.” In addition, the ITOS-CONT 301 starts a process to identify if the total transport time exceeds the expected value by branching off a sub-process to step 629 (FIG. 6C).

At step 613, the ITOS-CONT 301 instructs the ITOS-CMO 303 to interact with the field NRMS platform 201a (e.g., via the field configuration manager) and collects field environment information to use as a reference for the replication in the test NRMS platform 201b. If operational rules allow, a test resource allocation request is generated and directed towards the field NRMS platform 201a. The purpose of this option is to facilitate the scheduling of field information collection by inducing the problem, in particular in the cases where the problem does not occur frequently in the field.

At step 615, the ITOS-CONT 301 instructs the ITOS-CMO 303 to run a lab replication attempt and the ITOS-CONT 301 instructs and provides information to test NRMS platform 201b (e.g., via the test configuration manager) to run the test (e.g., replication attempt). If the test with the test NRMS platform 201b is successful in replicating the issue, the process moves to step 617. If not, the process moves to step 623.

At step 617, the ITOS-CONT 301 analyzes the test results and, depending on the nature of the issue, may identify new parameters to consider that may resolve the issue. By way of example, the ITOS-CONT 301 may detect that a security filter rule in a list on the field NRMS platform 201a is located towards the end of the list. The ITOS-CONT 301 may propose moving the corresponding rule towards the top to reduce the processing time. By way of another example, the test may reveal that the field NRMS platform 201a network interface, where resource allocation requests are received, is experiencing congestion. The ITOS-CONT 301 may propose modifying the QoS and treatment configuration on the field NRMS platform 201a to prioritize traffic associated with the particular application associated with the initial event (e.g., trigger).

At step 619, the ITOS-CONT 301 distributes the new parameters. In one embodiment, the ITOS-CONT 301 distributes vendor-independent parameters to the ITOS-CMO 303. The ITOS-CMO 303 then maps the vendor-independent parameters to the appropriate vendor-specific format/parameters. The ITOS-CMO 303 then provides the parameters to the test NRMS platform 201b (e.g., via the test configuration manager) such that the test NRMS platform 201b can prepare for running the validation of the new parameters.

At step 621, the test NRMS platform 201b then evaluates the new test parameters. Validation test results are then compiled by the test NRMS platform 201b. The test results may be compiled by the test configuration manager. Upon compiling the test results, they are forwarded to the ITOS platform 203, such as to the ITOS-CONT 301. The results are then available to test engineers for correcting the original issue or, in certain embodiments, the ITOS platform 203 can directly affect the field NRMS platform 201a to update the field design requirements and specifications 315a. The process proceeds to step 623 where results and actions are reported. At this point, this branch of the process ends.

As shown in FIG. 6C, at step 625, the ITOS-CONT 301 compares whether the NRMS associated processing time exceeds the corresponding value in the field design requirements and specifications 315a. If the time exceeds the expected value, the process 600 proceeds to step 627. If the measured value is equal or less than the expected value, the process 600 proceeds to step 631.

At step 627, the ITOS-CONT 301 marks this case as “Total transport time contributes to the delayed response” and starts a process with the objective of identifying the transport time of individual routing elements and links, as discussed above.

At 629, upon receiving the results associated with the routing elements and links, the ITOS-CONT 301 determines whether the measured value of the transport time exceeds the corresponding value in the field design requirements and specifications 315a, for each individual routing element and link. The ITOS-CONT 301 identifies those routing elements and links with transport delay exceeding the specifications, and marks them as offending routing elements and links. The ITOS-CONT 301 then provides such results for test engineers for troubleshooting the problem or, in certain embodiments, the ITOS platform 203 can directly affect the field NRMS platform 201a to update the field design requirements and specifications 315a to alleviate the issue, such as avoiding a routing element, and this branch of the process ends.

At step 631, the ITOS-CONT 301 compares the measured field NRMS platform 201a's processing time to the expected value. If the expected value is not exceeded, and that total transport time was shown before to remain within the expected limit, then this case is marked as “Unresolved issue,” and is forwarded to a higher tier of troubleshooting. and this branch of the troubleshooting ends.

By way of another example with respect to the FOM 313a-313c, FOM 313c can be for troubleshooting, root cause analysis and trouble replication of issues related to unexpected decisions and events associated with the policy based processing of resource allocation requests. One function of the field NRMS platform 201a upon receiving an allocation request is to provide an appropriate response to the requesting application based on the current network status. An example of an inaccurate decision (e.g., trigger event) is the rejection of a resource allocation request while in fact the network's current available resources can accommodate the desired resources demanded in the allocation request. This situation can occur, for example, as a result of inaccurate resource tracking information on the field NRMS platform 201a (e.g., NRMS has a view about the current network utilization that does not match the actual utilization).

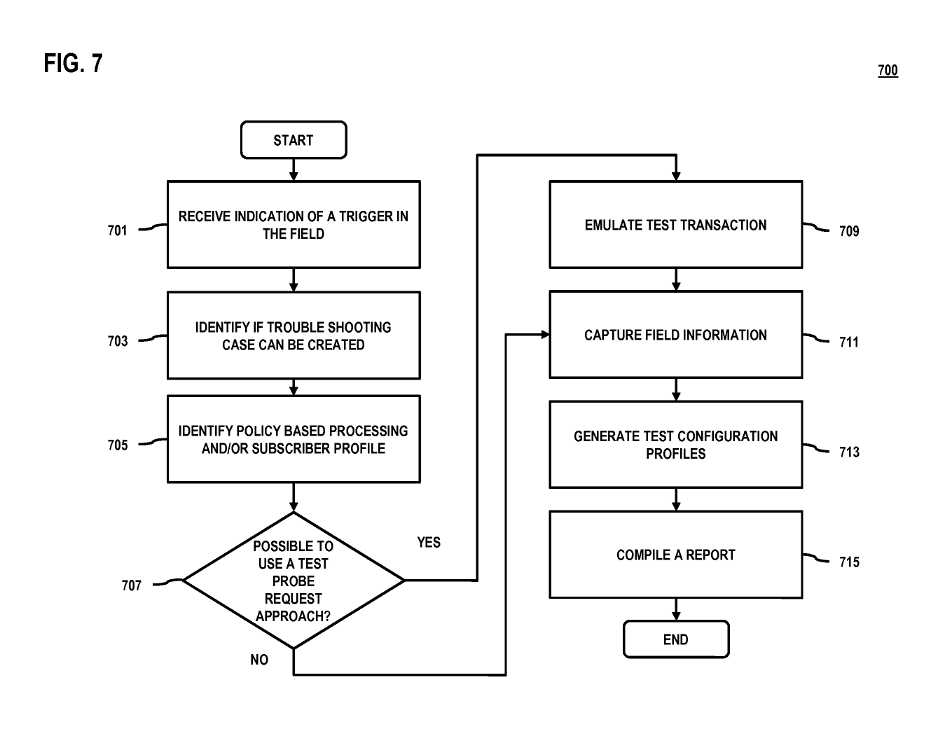

FIG. 7 is a flowchart of a process 700 for troubleshooting issues related to unexpected decisions and events associated with the policy based processing of resources allocation requests, according to one embodiment. In one embodiment, the ITOS platform 203 performs the process 700 and is implemented in, for instance, a chip set including a processor and a memory as shown in FIG. 8. As discussed above, the ITOS platform 203's core components may, in one embodiment, by instructed to perform the process 700 according to an FOM (e.g., FOM 313c).

At step 701, the ITOS platform 203 receives an indication of a trigger associated with an unexpected decision and/or event associated with policy-based processing. The trigger may be associated with an indication of the occurrence of unexpected policy decisions related to policy processing of resource allocation requests in the field NRMS platform 201a. By way of example, a customer may complain about the rejection of a resource allocation request without an acceptable justification for such rejection. The subscriber may provide a rejection code that was associated with the received rejection. For example, a customer application may have generated an allocation request to receive a BoD session for 2 hours of 20 Mbps bandwidth, and this request may have been rejected even though the customer account is in a good condition and the customer home circuit is capable of supporting the requested resources (e.g., the bandwidth).

By way of another example, the trigger may be associated with detecting inconsistency indications and/or unexpected events from a traffic engineering team using a tool that analyzes the history/statistics of allocation request rejections. This analysis may indicate a large percentage of rejections while the network is engineered to support such demand with sufficient extra capacity. Further, a monitoring system may not be showing congestion on the network where resources should have been allocated. Typically, traffic engineering observations are concerned about long term trends. Such an example is observing that 1% of resource allocation requests in the New York area are being rejected because a tracking database within the field NRMS platform 201a identified overutilization (e.g., lack of available resources) on a the 1 Gbps link between two routers. On the other hand, a traffic engineering tool may indicate that bandwidth utilization on the same link never exceeded 50% at any time during the week when the unexpected event was observed. Considering that the traffic engineering tool compiles its allocation tracking information using a different mechanism than that of the field NRMS platform 201a, this situation may suggest an issue with the accuracy of the tracking information on one of the systems.

By way of another example, the trigger may be associated with inaccurate results associated with automatic verification. An operator may select to run testing in the field on regular intervals to verify the health of the overall network. Automatic verification typically runs on shorter time intervals to capture inaccurate resource allocation request processing that may not be frequent to impact long term trends.

At step 703, information received in the trigger indication is analyzed to identify if a troubleshooting case can be created. In this step, the ITOS-CONT 301 can verify that the information in the trigger is sufficient for troubleshooting, such as if the information verifies if the trigger notification provides information on the link on which the NRMS policy-based allocation was attempted. In some situations, the ITOS-CONT 301 may find that no information is available, or the level of available information is not sufficient to proceed with troubleshooting. As an example of this situation, applied to the second example above, assume that information on the link between the two routers was not available to the ITOS-CONT 301, such as because this segment in the network path is under the control of third party provider that does not allow/authorize the access of such information. In this case, the ITOS-CONT 301 cannot extract necessary information that is needed to provide any meaningful troubleshooting. In which case the ITOS platform 203 will not proceed with the creation of a troubleshooting case. In one embodiment, also at step 703, the ITOS-CONT 301 also identifies if the issue characteristics appear to be related to network utilization policies, or to a subscriber policy and profile. Such a classification can help in identifying the scope of needed testing, and the involved elements and systems. Based on the information received in the notification of the event, the ITOS-CONT 301 identifies the field NRMS platform 201a (e.g., where there is more than one within the system 200), routing elements and links that are relevant to this event.

At step 705, the ITOS platform 203 via the ITOS-CONT 301 retrieves from the field design and requirements specifications 313a the policy based processing and/or subscriber profile for the identified elements and links. This information is used to identify the expected behavior and parameters associated with this subscriber, and network segments involved in providing service to this subscriber, and the applicable policy rules.

At step 707, the ITOS-CONT 301 can identify an approach regarding troubleshooting and whether the issue can be replicated in a controlled manner in the test environment. This can be accomplished by constructing and generating a customized test resource allocation request transaction towards the field NRMS platform 201a. The ability to generate this request in the field environment in a controlled manner allows for capturing more realistic and relevant information. If operational rules associated with the field environment allow the generation of test transactions in that environment, the process 700 proceeds to step 709. If operational rules associated with the field environment do not allow the generation of any test transactions in that environment, the process 700 proceeds to step 711.

At step 709, the ITOS-CONT 301 constructs a customized test transaction that mimics the transaction associated with the troubleshooting case. For example, considering the issue of the first example for step 701 above, the test transaction will emulate an allocation request to receive a BoD session for 2 hours of 20 Mbps bandwidth, and will be treated such that it appears as associated with the same subscriber profile and network segments as those in the troubleshooting case. Such an arrangement can aid in identifying that the transaction is handled in a manner as close as possible, if not identical, to the same handling of the transaction under consideration that generated the original trigger. After constructing the test transaction, it is sent to the field NRMS platform 201a.

At step 711, the ITOS platform 203 captures the field information relevant to the replication of the observed issue. If generating a test transaction is allowed, collecting the information from the field is synchronized with the test transaction generation. If test transaction is not allowed in the field, the field environment descriptors collection is scheduled to occur in a time interval during which the problem occurs. It is noted that more than one capture can be collected. The collection approach is similar to the approaches discussed above. The collected information may include the following: the maximum rate of resource allocation requests, resource allocation request burstness (burst rate and burst size); maximum rate of subscriber end point transaction, subscriber end point transactions burstness characteristics (burst rate and burst size), topology transaction maximum rate, topology transaction burst rate and burst size, topology transaction maximum size for each transaction type, object and sub-object, where transaction types include create, delete and update, subscriber profile transaction maximum rate, subscriber transaction burst rate and burst size, in particular, the following aspects related to utilization are collected: existing network resource allocation just before the occurrence of the event under consideration, topology information specifying maximum capacity for the network links and segments associated with the event under consideration, existing subscriber resource allocation just before the occurrence of the event under consideration, topology information specifying maximum capacity for the subscriber links and segments associated with the event under consideration, and subscriber service provider, and subscriber specific configurations.

At step 713, after collecting, analyzing and extracting the corresponding parameters from the field information, the ITOS-CONT 301 instructs the ITOS-CMO 303 to generate one or more test configuration profiles. Typically, the intention of the first profile is to verify the ability to recreate the problem using a test environment associated with the test NRMS platform 201b that is close as possible to the field configuration. Accordingly, minimum or no changes are made relative to the descriptors collected from the field. Other profiles may be created to verify the sensitivity of the problem to the different parameters (e.g., the impact of changing parameters on the ability to recreate the problem, or the magnitude and characteristics of the problem). The ITOS-CMO 303 then schedules the test cycles using the corresponding profiles, and results are provided to the ITOS-CONT 301.

At step 715, the ITOS platform 203 via the ITOS-CONT 301 compiles a report that can be used by the test engineer to provide information regarding the problem. In one embodiment, the report may also include proposed resolution. In one embodiment, the ITOS platform 203 may further implement the proposed resolution, if feasible, without any operator intervention to alleviate the issue.

By way of an additional example, the following is a specific example based on the foregoing process 700 of FIG. 7. A subscriber's request (e.g., subscriber ID NY-Data-Video_{—}12345678) for a BoD session of 30 Mbps downstream may have been rejected with an error code indicating an existing allocation of 15 Mbps associated with a video application. If the new BoD request is accepted, the total allocation will exceed the subscriber maximum capacity of 40 Mbps. The subscriber may complain to the service provider about this situation, and the service provider can create an internal trouble report, which translates into a trigger to the ITOS-CONT 301 to start looking into troubleshooting this case (step 701). ITOS-CONT 301 starts a process to confirm that information associated with the trigger notification in A is sufficient to troubleshoot the issue (step 703). The ITOS-CONT 301 instructs the ITOS-CMO 303 to verify that it can use the subscriber ID to query the field NRMS platform 201a (such as the field configuration manager associated with the field NRMS platform 201a) to receive information on the service profile associated with the subscriber, subscriber account status and the maximum capacity supported by the subscriber circuit. The ITOS-CONT 301 instructs ITOS-CMO 303 to trigger the field NRMS platform 201a to report the current allocation (as seen by the field NRMS platform 201a) associated with the subscriber to the field event module 305a. The ITOS-CMO 303 confirms to the ITOS-CONT 301 that the needed information is available. The ITOS-CONT 301 then inspects the information, identifies that the issue is related to the subscriber aspects, and not the network aspects, such as the subscriber segment, policy and rules (step 705).

If the ITOS-CONT 301 confirms that operational rules allows the generation of a test probe request towards the field NRMS platform 201a providing service to this particular subscriber (step 707), then the ITOS-CONT 301 can construct an allocation request that mimics the failed request associated with this troubleshooting case (step 709). Accordingly, a request for a BoD session for 30 Mbps downstream is generated towards the field NRMS platform 201a. The test transaction request may be generated by the ITOS-CONT 301, or the ITOS-CONT 301 may trigger the corresponding application (BoD in this case) to generate such a request. In one scenario, the result of sending the transaction test is recorded and, in one case, the test transaction request is rejected for the same reason as in the troubleshooting case request, which confirms the behavior observed in the case.

The ITOS-CONT 301 then captures the field configuration associated with the event under consideration (step 711). In this example, information related to the subscriber segment and subscriber policies is collected. The ITOS-CONT 301 also captures the log history associated with the subscriber under consideration to verify existing allocations and that each previous resource allocation has a corresponding resource release. Such a log can indicate the following: Log analysis: Time Period considered for Analysis (Date/Time): From Oct. 24, 2012 @ 8:00:00 To Oct. 29, 2012 @ 9:30:12; Subscriber ID: NY-Data-Video_{—}12345678; Last transaction associated with subscriber: Granted a Video on Demand (VoD) request allocation for 15 Mbps @ Oct. 28, 2012 @ 8:48:10; and Release associated with last transaction: No record. The ITOS-CONT 301 analyzes the status and compares the time stamps of the last accepted allocation to the current time, and finds that there was no allocation release request associated with the VoD (as if the VoD session was active for more than 24 hours). This is an indication of unexpected behavior on the application side since the corresponding resource release was not generated with the appropriate VoD run time (less than two hours from the VoD start).

To confirm the analysis and the root cause of this issue, the ITOS-CONT 301 instructs the ITOS-CMO 303 to provision the test NRMS platform 201b to mimic the environment experienced in the field NRMS platform 201a (step 713). The objective is to confirm that the observed field issue will occur in the test environment in a similar manner, confirming the analysis. First, the test is implemented with an existing 15 Mbps allocation (emulating the situation resulting from the missing resource release). This test will show that the BoD allocation request is rejected by the test NRMS platform 201b. The second test verifies a resolution, by generating a customized allocation release test transaction, which is directed towards the test NRMS platform 201b. The ITOS-CONT 301 instructs the ITOS-COM 303 to confirm the status of the current allocation on the subscriber segment, and confirm that the test transaction was successful in releasing the resources. After confirming the resource release, ITOS-CONT 301 constructs and transmits an allocation request that mimics the failed request associated with this troubleshooting case. Accordingly, a request for BoD session for 30 Mbps downstream is generated towards the test NRMS platform 201b. The test transaction request may be generated by the ITOS-CONT 301, or the ITOS-CONT 301 may trigger the corresponding application (BoD in this case) emulator to generate such request. This time, the test allocation request is successful, confirming the root cause, and the workaround. Depending on the user preference and operational rules, the ITOS platform 203 can also be configured to generate a customized allocation release transaction, which is directed towards the field NRMS platform 201a, thereby resolving the field issue.

Subsequently, results are compiled, including the root cause analysis and the proposed work around, and sent to the test engineer (step 715).

The processes described herein for providing interactive automated testing and deployment/field troubleshooting may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 8 illustrates computing hardware (e.g., computer system) upon which an embodiment according to the invention can be implemented. The computer system 800 includes a bus 801 or other communication mechanism for communicating information and a processor 803 coupled to the bus 801 for processing information. The computer system 800 also includes main memory 805, such as random access memory (RAM) or other dynamic storage device, coupled to the bus 801 for storing information and instructions to be executed by the processor 803. Main memory 805 also can be used for storing temporary variables or other intermediate information during execution of instructions by the processor 803. The computer system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computer system 800 may be coupled via the bus 801 to a display 811, such as a cathode ray tube (CRT), liquid crystal display, active matrix display, or plasma display, for displaying information to a computer user. An input device 813, such as a keyboard including alphanumeric and other keys, is coupled to the bus 801 for communicating information and command selections to the processor 803. Another type of user input device is a cursor control 815, such as a mouse, a trackball, or cursor direction keys, for communicating direction information and command selections to the processor 803 and for controlling cursor movement on the display 811.

According to an embodiment of the invention, the processes described herein are performed by the computer system 800, in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multiprocessing arrangement may also be employed to execute the instructions contained in main memory 805. In alternative embodiments, hard-wired circuitry may be used in place of or in combination with software instructions to implement the embodiment of the invention. Thus, embodiments of the invention are not limited to any specific combination of hardware circuitry and software.

The computer system 800 also includes a communication interface 817 coupled to bus 801. The communication interface 817 provides a two-way data communication coupling to a network link 819 connected to a local network 821. For example, the communication interface 817 may be a digital subscriber line (DSL) card or modem, an integrated services digital network (ISDN) card, a cable modem, a telephone modem, or any other communication interface to provide a data communication connection to a corresponding type of communication line. As another example, communication interface 817 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 817 sends and receives electrical, electromagnetic, or optical signals that carry digital data streams representing various types of information. Further, the communication interface 817 can include peripheral interface devices, such as a Universal Serial Bus (USB) interface, a PCMCIA (Personal Computer Memory Card International Association) interface, etc. Although a single communication interface 817 is depicted in FIG. 8, multiple communication interfaces can also be employed.

The network link 819 typically provides data communication through one or more networks to other data devices. For example, the network link 819 may provide a connection through local network 821 to a host computer 823, which has connectivity to a network 825 (e.g. a wide area network (WAN) or the global packet data communication network now commonly referred to as the “Internet”) or to data equipment operated by a service provider. The local network 821 and the network 825 both use electrical, electromagnetic, or optical signals to convey information and instructions. The signals through the various networks and the signals on the network link 819 and through the communication interface 817, which communicate digital data with the computer system 800, are exemplary forms of carrier waves bearing the information and instructions.

The computer system 800 can send messages and receive data, including program code, through the network(s), the network link 819, and the communication interface 817. In the Internet example, a server (not shown) might transmit requested code belonging to an application program for implementing an embodiment of the invention through the network 825, the local network 821 and the communication interface 817. The processor 803 may execute the transmitted code while being received and/or store the code in the storage device 809, or other non-volatile storage for later execution. In this manner, the computer system 800 may obtain application code in the form of a carrier wave.

The term “computer-readable medium” as used herein refers to any medium that participates in providing instructions to the processor 803 for execution. Such a medium may take many forms, including but not limited to non-volatile media, volatile media, and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

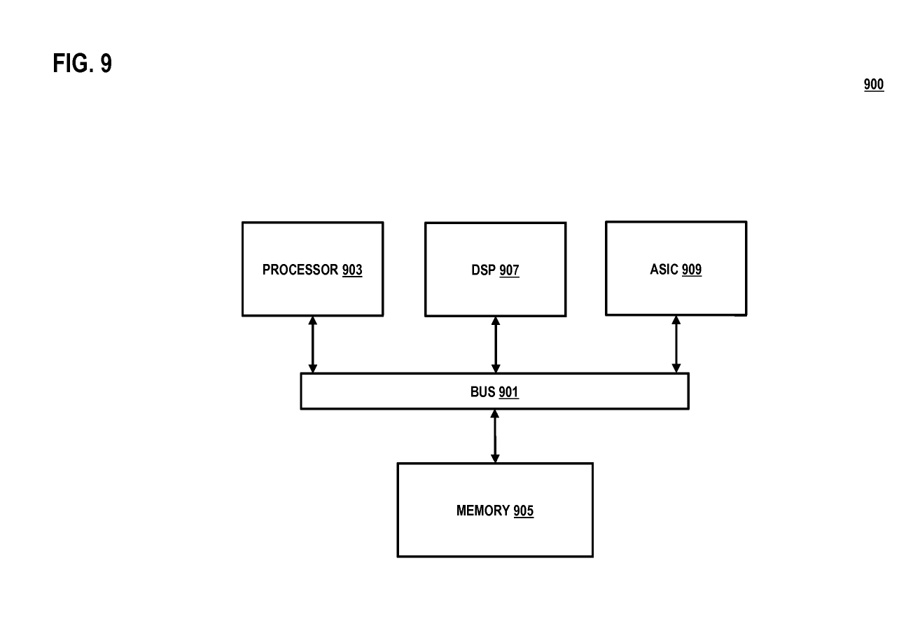

FIG. 9 illustrates a chip set 900 upon which an embodiment of the invention may be implemented. Chip set 900 is programmed for interactive automated testing and deployment field troubleshooting, as described herein, and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 900, or a portion thereof, constitutes a means for performing one or more steps of FIGS. 4, 6 and 7.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 905 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
extracting one or more field parameters associated with a deployed network resource management environment;
determining and/or updating one or more test parameters associated with a test network resource management environment based on the one or more field parameters;
inputting the determined and/or updated test parameters within the test network resource management environment to evaluate the one or more test parameters; and
modifying a configuration of at least one of the deployed network resource management environment and the test network resource management environment based on the one or more evaluated test parameters.

2. A method according to claim 1, further comprising:
acquiring information associated with the deployed network resource management environment; and
extracting the one or more field parameters from the acquired information,
wherein the information is acquired based on one or more logs, capturing traffic information, information available on the deployed network resource management environment, or a combination thereof associated with the deployed network resource management environment.

3. A method according to claim 1, further comprising:
identifying one or more test cases associated with the test network resource management environment based on at least one of the one or more field parameters and the one or more test parameters; and
updating the one or more test cases based on the one or more field parameters, the configuration of the test network resource management environment, or a combination thereof.

4. A method according to claim 3, wherein the one or more test cases are initially based on an original configuration of the deployed network resource management environment and the one or more test cases are updated to account for real-world variations within the deployed network resource management environment.

5. A method according to claim 1, further comprising:
mapping vendor-independent instructions to vendor-specific instructions for use in both the deployed network resource management environment and the test network resource management environment for at least one of extracting the one or more field parameters and evaluating the test parameters.

6. A method according to claim 1, further comprising:
determining an occurrence of a triggering event associated with the one or more field parameters compared to one or more performance thresholds within the deployed network resource management environment,
wherein the evaluation of the one or more test parameters is with respect to the one or more performance thresholds.

7. A method according to claim 6, wherein the triggering event is based on an error associated with a resource allocation request and/or unexpected events related to functional and operational aspects of the deployed network resource management environment.

8. An apparatus comprising:
a communication port configured to one or more field parameters associated with a deployed network resource management environment; and
a processor configured to determine and/or update one or more test parameters associated with a test network resource management environment based on the one or more field parameters, input the determined and/or updated test parameters within the test network resource management environment to evaluate the one or more test parameters, and modify a configuration of at least one of the deployed network resource management environment and the test network resource management environment based on the one or more evaluated test parameters.

9. An apparatus according to claim 8, wherein:
the communication portion is further configured to: receive information associated with the deployed network resource management environment; and
the processor is further configured to extract the one or more field parameters from the acquired information,
wherein the information is acquired based on one or more logs, capturing traffic information, information available on the deployed network resource management environment, or a combination thereof associated with the deployed network resource management environment.

10. An apparatus according to claim 8, where the processor is further configured to:
identify one or more test cases associated with the test network resource management environment based on at least one of the one or more field parameters and the one or more test parameters; and
update the one or more test cases based on the one or more field parameters, the configuration of the test network resource management environment, or a combination thereof.

11. An apparatus according to claim 10, wherein the one or more test cases are initially based on an original configuration of the deployed network resource management environment and the one or more test cases are updated to account for real-world variations within the deployed network resource management environment.

12. An apparatus according to claim 8, wherein the processor is further configured to:
map vendor-independent instructions to vendor-specific instructions for use in both the deployed network resource management environment and the test network resource management environment for at least one of extracting the one or more field parameters and evaluating the test parameters.

13. An apparatus according to claim 8, wherein the processor is further configured to:
determine an occurrence of a triggering event associated with the one or more field parameters compared to one or more performance thresholds within the deployed network resource management environment,
wherein the evaluation of the one or more test parameters is with respect to the one or more performance thresholds.

14. An apparatus according to claim 13, wherein the triggering event is based on an error associated with a resource allocation request and/or unexpected events related to functional and operational aspects of the deployed network resource management environment.

15. A system comprising:
a deployed network resource management environment for managing allocation resource requests associated with a network;
a test network resource management environment for testing cases associated with the deployed network resource management environment; and
a support platform configured to extract one or more field parameters associated with the deployed network resource management environment, determine and/or update the one or more test parameters associated with the test network resource management environment based on the one or more field parameters, input the determined and/or updated test parameters within the test network resource management environment to evaluate the one or more test parameters, and modify a configuration of at least one of the deployed network resource management environment and the test network resource management environment based on the one or more evaluated test parameters.

16. A system according to claim 15, further comprising:
the support platform being configured to acquire information associated with the deployed network resource management environment, and extract the one or more field parameters from the acquired information,
wherein the information is acquired based on one or more logs, capturing traffic information, information available on the deployed network resource management environment, or a combination thereof associated with the deployed network resource management environment.

17. A system according to claim 16, further comprising:
the support platform being configured to identify one or more test cases associated with the test network resource management environment based on at least one of the one or more field parameters and the one or more test parameters, and update the one or more test cases based on the one or more field parameters, the configuration of the test network resource management environment, or a combination thereof.

18. A system according to claim 17, wherein the one or more test cases are initially based on an original configuration of the deployed network resource management environment and the one or more test cases are updated to account for real-world variations within the deployed network resource management environment.

19. A system according to claim 15, further comprising:
the support platform being configured to map vendor-independent instructions to vendor-specific instructions for use in both the deployed network resource management environment and the test network resource management environment for at least one of extracting the one or more field parameters and evaluating the test parameters.

20. A system according to claim 15, further comprising:
the support platform being configured to determine an occurrence of a triggering event associated with the one or more field parameters compared to one or more performance thresholds within the deployed network resource management environment,
wherein the evaluation of the one or more test parameters is with respect to the one or more performance thresholds, and the triggering event is based on an error associated with a resource allocation request and/or unexpected events related to functional and operational aspects of the deployed network resource management environment.
